(19) United States
(12) Patent Application Publication
(10) Pub. No.: US 2022/0318192 A1
(43) Pub. Date: Oct. 6, 2022

(54) METHOD AND APPARATUS FOR DISPLAYING EVENT INFORMATION, STORAGE MEDIUM AND ELECTRONIC DEVICE

(71) Applicant: BOE TECHNOLOGY GROUP CO., LTD., Beijing (CN)

(72) Inventor: Ruixiang CHEN, Beijing (CN)

(21) Appl. No.: 17/427,218

(22) PCT Filed: Sep. 29, 2020
(86) PCT No.: PCT/CN2020/119042

§ 371 Date: Jul. 30, 2021

(51) Int. Cl. G06F 16/14; H04N 21/6437; G06F 3/147

(52) U.S. Cl. CPC G06F 16/14; H04N 21/6437; G06F 3/147

(57) ABSTRACT

A method for displaying event information, includes: determining an event category and event information of an event to be displayed; determining a target template in a template library according to the event category, wherein the template library includes reference templates corresponding to multiple event categories; generating, based on the event information, a picture corresponding to the event to be displayed by using the target template; and, displaying the picture on an electronic signage corresponding to the event to be displayed.

### TECHNICAL FIELD

The present disclosure relates to the technical field of information displaying and, in particular, to a method and an apparatus for displaying event information, a computer-readable storage medium and an electronic device.

### BACKGROUND

With the rapid development of electronic products, the application of electronic signages has become more and more extensive. However, the content of electronic signages in related art cannot be customized, is often closely associated with specific events and, thus, cannot be adapted to different events. Moreover, the content displayed by electronic signages is typically unable to be edited freely, or the effect seen during editing is inconsistent with the effect presented by the electronic signage.

Therefore, it is necessary to design a new method for displaying event information.

### SUMMARY

According to a first aspect of the disclosure, there is provided a method for displaying event information, including:

determining an event category and event information of an event to be displayed;

determining a target template in a template library according to the event category, wherein the template library includes reference templates corresponding to multiple event categories;

generating, based on the event information, a picture corresponding to the event to be displayed by using the target template; and

displaying the picture on an electronic signage corresponding to the event to be displayed.

In some exemplary embodiments of the disclosure, the method further includes:

determining whether there is a reference template matching the event category of the event to be displayed in the template library; and

determining, in response to determining there is the reference template matching the event category of the event to be displayed in the template library, the target template in the template library according to the event category.

In some exemplary embodiments of the disclosure, the method further includes:

generating, in response to determining there is no reference template matching the event category of the event to be displayed in the template library, the target template according to the event category and storing the target template in the template library.

In some exemplary embodiments of the disclosure, the generating, based on the event information, the picture corresponding to the event to be displayed by using the target template includes:

determining a display mode and at least one display area of the target template according to the event category; and

determining a display size and a display parameter of each display area in the target template;

wherein the display mode includes at least one of text, coded pattern and non-coded pattern.

In some exemplary embodiments of the disclosure, the method further includes:

updating the target template in response to an editing operation of a user on the target template.

In some exemplary embodiments of the disclosure, the updating the target template in response to the editing operation of the user on the target template includes:

in response to a modification operation of the user on a display mode of the target template, modifying the display mode of the target template; and/or

in response to an adjustment operation of the user on a display area of the target template, adjusting at least one of a display size, number, and a display parameter of the display area.

In some exemplary embodiments of the disclosure, the generating, based on the event information, the picture corresponding to the event to be displayed by using the target template includes:

extracting a service field of the event to be displayed;

inputting the service field into the target template, causing the target template to obtain event information of the event to be displayed according to the service field; and

generating, based on the event information, the picture corresponding to the event to be displayed by using the target template.

In some exemplary embodiments of the disclosure, the event to be displayed includes at least one target to be displayed, and generating, based on the event information, the picture corresponding to the event to be displayed by using the target template includes:

generating, based on the event information, a picture corresponding to each target to be displayed by using the target template.

In some exemplary embodiments of the disclosure, before displaying the picture on the electronic signage corresponding to the event to be displayed, the method further includes:

acquiring a map of multiple electronic signages;

assigning, in response to a user operation, a target to be displayed to each of the electronic signages in the map; and

binding a picture to be displayed to the electronic signage corresponding to one or more targets to be displayed.

In some exemplary embodiments of the disclosure, the displaying the picture on the electronic signage corresponding to the event to be displayed includes:

displaying, in response to a display triggering operation of a user, the picture on a corresponding electronic signage; or

displaying the picture on the corresponding electronic signage automatically after a preset time period, or

displaying the picture on the corresponding electronic signage automatically at a preset time point.

In some exemplary embodiments of the disclosure, the displaying the picture on the electronic signage corresponding to the event to be displayed includes:

converting the picture into a readable format of the electronic signage to be displayed on the electronic signage corresponding to the event to be displayed.

According to an aspect of the disclosure, there is provided an apparatus for displaying event information, including:

a determining module, configured to determine an event category and event information of an event to be displayed;

a matching module, configured to determine a target template in a template library according to the event category, wherein the template library includes reference templates corresponding to multiple event categories;

a generating module, configured to generate, based on the event information, a picture corresponding to the event to be displayed by using the target template; and

a displaying module, configured to display the picture on an electronic signage corresponding to the event to be displayed.

According to an aspect of the disclosure, there is provided a computer-readable storage medium storing a computer program therein, wherein the program is executable by a processor to implement the method for displaying event information according to any embodiment described above.

According to an aspect of the disclosure, there is provided an electronic device, including:

a processor; and

a memory, configured to store one or more programs, wherein the one or more programs, when being executed by one or more processors, causes the one or more processors to implement the method for displaying event information according to any embodiment described above.

### BRIEF DESCRIPTION OF THE DRAWINGS

The drawings herein, which are incorporated in and constitute a part of this specification, illustrate embodiments consistent with the present disclosure, and serve to explain the principles of the present disclosure together with the description. Obviously, the drawings in the following description are just some embodiments of the present disclosure. For those of ordinary skill in the art, other drawings may be obtained based on these drawings without creative efforts.

FIG. 1 is a schematic diagram illustrating an exemplary system architecture that can be applied to the method for displaying event information according to an embodiment of the disclosure.

FIG. 2 schematically illustrates a flow chart of the method for displaying event information according to an exemplary embodiment of the disclosure.

FIG. 3 schematically illustrates a schematic diagram of a template editing interface according to an exemplary embodiment of the disclosure.

FIG. 4 schematically illustrates a flowchart of binding an event to be displayed with an electronic signage according to an exemplary embodiment of the disclosure.

FIG. 5 schematically illustrates a flowchart of the method for displaying event information when there is no template matching the event to be displayed in the template library according to an exemplary embodiment of the disclosure.

FIG. 6 schematically illustrates a block diagram of the apparatus for displaying event information according to an exemplary embodiment of the disclosure.

FIG. 7 schematically illustrates a block diagram of a computer system suitable for implementing the electronic device according to an exemplary embodiment of the disclosure.

FIG. 8 schematically illustrates a schematic diagram of the computer-readable storage medium according to some embodiments of the disclosure.

### DETAILED DESCRIPTION

Example implementations will now be described more fully with reference to the accompanying drawings. However, the example implementations can be implemented in various forms and should not be construed as limited to the implementations set forth herein; rather, these implementations are provided so that this disclosure will be thorough and complete, and will fully convey the concept of the example implementations to those skilled in the art. The described features, structures or characteristics can be combined in one or more embodiments in any suitable way.

In addition, the drawings are merely schematic illustrations of the present disclosure and are not necessarily drawn to scale. The same reference numerals in the drawings denote the same or similar parts, and thus their repeated description will be omitted. Some of the block diagrams shown in the drawings are functional entities and do not necessarily correspond to physically or logically independent entities. These functional entities may be implemented in the form of software, or implemented in one or more hardware modules or integrated circuits, or implemented in different networks and/or processor devices and/or microcontroller devices.

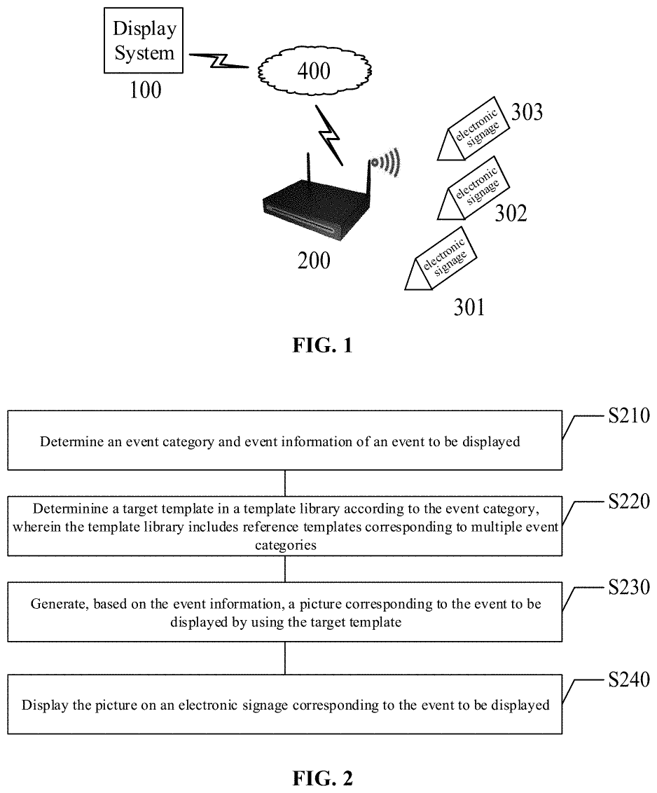

Referring to FIG. 1, which is a schematic diagram illustrating an exemplary system architecture that can be applied to the method for displaying event information according to an embodiment of the disclosure, the system architecture includes a display system 100, a gateway device 200, an electronic signage 301, an electronic signage 302, and an electronic signage 303.

In some embodiments, the display system 100 may be an independent display device with information processing capability, for example, a conference machine in an office scenario, which contains a display and a processor. It may also be a system that includes a display and wireless connected devices, a system that includes a display and a server, or a system that includes a display and a gateway.

The display system 100 and the gateway device 200 are connected through the network 400. The gateway device 200 receives the content (referred to as the signage content hereinafter) that needs to be displayed or executed by the electronic signage 301, electronic signage 302, and electronic signage 303 from the display system 100, and sends the signage content to a corresponding electronic signage when the electronic signage 301, electronic signage 302 and the electronic signage 303 are connected to the gateway device 200.

The network 400 may include different types of networks such as wired, wireless, or fiber optic cables. Each of the electronic signage 301, electronic signage 302, and electronic signage 303 may be a single-sided display electronic signage or a double-sided display electronic signage. For a double-sided display electronic signage, it can be assembled from two independent single-sided display electronic signages back-to-back, or it can be a double-sided display with the display surfaces thereof facing away from each other. The content displayed on two sides of the double-sided electronic signage can be the same or different.

It should be understood that the numbers of gateway devices, networks, and electronic signages in FIG. 1 are merely illustrative. According to implementation needs, there can be any number of gateway devices, networks, and electronic signages. In addition, the display system 100 can be connected to multiple gateway devices at the same time, and each gateway device can be connected to multiple electronic signages at the same time.

The electronic signage can be a display device that can display content, and can be a device that can be wall-mounted, placed, or portable, such as conference table cards, station cards, house cards, electronic work cards (also called electronic business cards), visitor cards, door plates for advertising display, elevator cards, bus stop signs, presentation signage used in museums or exhibition halls for display in different positions, and the like.

In some exemplary embodiment, a method for displaying event information is first provided, which can be applied to the introduction of characters in a conference scenario, and can also be used in fields such as prices obtained in supermarkets and introduction of related plants in parks. Referring to FIG. 2, the foregoing method for displaying event information may include the following steps.

In S210, an event category and event information of an event to be displayed are determined.

In S220, a target template is determined in a template library according to the event category, wherein the template library includes reference templates corresponding to multiple event categories.

In S230, based on the event information, a picture corresponding to the event to be displayed is generated by using the target template.

In S240, the picture is displayed on an electronic signage corresponding to the event to be displayed.

According to the method for displaying event information provided In some exemplary embodiments, compared with related art, on the one hand, corresponding target templates are used to generate and display corresponding pictures according to different events, thereby adapting to different events. On the other hand, the target template is used to generate pictures for display, so that the display content is exactly the same as that displayed on the target template. In other words, using the picture for display enables the effect displayed on the electronic signage to be consistent with the expected effect. On another hand, the target template can be directly used to generate the pictures corresponding to the event to be displayed for presentation, thereby realizing automatic display, avoiding errors that may be caused by human input, and improving the accuracy of the event information display of the electronic signage.

Hereinafter, each step of the method for displaying event information In some exemplary embodiments will be described in more detail with reference to the accompanying drawings and embodiments.

In step S210, the event category and event information of the event to be displayed are determined.

In some exemplary embodiments of the disclosure, the server may first obtain the event to be displayed. The event to be displayed may be an event for displaying information such as the name, position, and gender of each person in a conference scenario, or may be an event for displaying information such as price and weight of various goods on supermarket shelves, or may be an event for displaying the names and ages of various plants in a park. The exemplary embodiments are not limited to any specific event to be displayed.

In some exemplary embodiments, the event category may include event scenarios, such as conference, goods pricing, plant signatures, and the like, which are not specifically limited in the embodiments. The event information may include the specific information of the above-mentioned characters, the specific details of the goods, the specific information of the plants, and the like.

In step S220, the target template is determined in the template library according to the event category, wherein the template library includes reference templates corresponding to multiple event categories.

In some exemplary embodiments of the disclosure, the template library may be established in advance, and the template library includes reference templates corresponding to multiple event categories, that is, reference templates corresponding to event categories such as the above-mentioned conference, goods price, plant signature, and the like may be included. The reference template in the template library may be created by the user, or may be obtained, for example, by downloading from the Internet or by sharing from other users, which is not specifically limited In some exemplary embodiments.

In some exemplary embodiments, the server may first determine whether there is a target template corresponding to the event category of the event to be displayed in the template library, and if yes, it may determine a target template in the template library according to the event category of the event to be displayed.

In some exemplary embodiments of the present disclosure, an event category can correspond to multiple target templates. After the target template is matched, preview images of multiple target templates can be shown to the user, and a trigger operation of the user on one of the preview template images can be received, thereby determining the target template corresponding to the trigger operation to complete the conversion from the event to be displayed to the event information.

In some exemplary embodiments, the trigger operation may be that the user clicks a preview image on a touch interface, or uses the mouse, keyboard, gestures, and the like to select the target template as desired. The specific selection method is not limited in the exemplary embodiments.

In some exemplary embodiments, the target template may include multiple display modes, which may include text, pictures, two-dimensional codes, and the like, and the target template includes at least one display area. The following takes the event to be displayed as a conference as an example to explain the at least one display area. In a conference scenario, the name, title, company, gender and other information of the conference personnel will generally be displayed on the electronic signage. In this case, the target template may include at least one display area such as a company name display area, a name display area, a title display area, and a gender display area. The number of display areas in the target template can be adjusted according to the needs of the user, which is not specifically limited in the exemplary embodiments.

In some exemplary embodiments, after the target template is determined through matching, the server may, in response to an editing operation of the user, display an editing and preview interface of the template on the graphical user interface, which is used by the user to adjust and update the target template.

Specifically, the display mode of the target template may be modified in response to the user's modification operation on the display mode of the target template; and/or at least one of a display size, number and a display parameter of a display area may be adjusted in response to the user's adjustment operation on the display area of the target template.

For example, the display mode is adjusted from a picture to a QR code, the display size of the display area is adjusted to a larger size, the number of display areas is increased or decreased, a display character format of the display area is adjusted, and the like. The embodiments are not limited thereto.

In some exemplary embodiments, if the target template corresponding to the event category of the event to be displayed does not exist in the template library, the template editing interface can be displayed directly on the graphical user interface, and the user can create a target template corresponding to the event to be displayed according to his/her requirements.

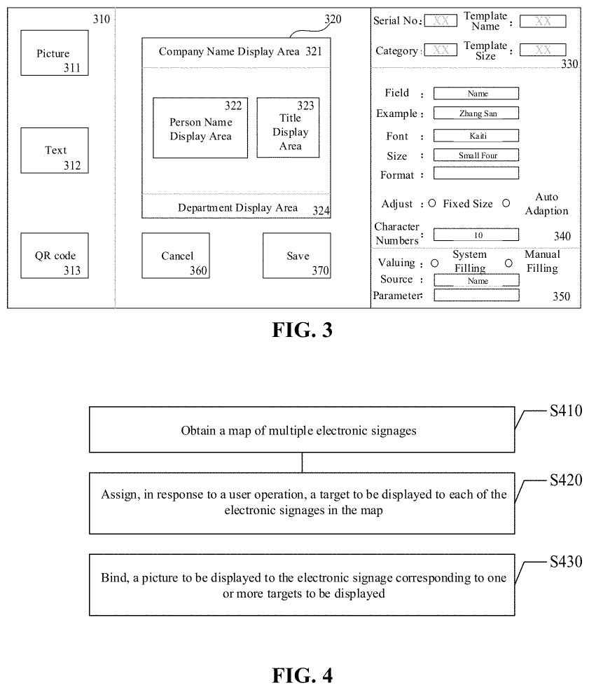

In some exemplary embodiments, referring to FIG. 3, the template editing interface may include a template display mode selection area 310, a template preview area 320, a template information display area 330, a template content input area 340, and a field binding area 350. In the template preview area 320, the size of each area in the template, the displayed content of each area, and the font size of the displayed content can be adjusted to complete creation of the template.

Specifically, when creating a target template, the size of the template and the display mode of the template can be firstly determined, then the number of display areas in the template can be determined, and then the display size, display parameters, and content to be displayed for each display area in the template can be determined. The display parameters may include the font size and character format of each display area. Finally, the information source of each display area can be set.

The following is a detailed description of creation of the template by taking the template of the conference scenario as an example.

Specifically, referring to FIG. 3, the display mode of the template is firstly determined in the template display mode selection area 310. For example, the display mode includes picture 311, text 312, two-dimensional code 313 and the like. Then a template is defined, the serial number, name, size, and type of the template are determined in the template information display area 330, and the size and position of each display area are set in the template preview area 320. For example, a company name display area 321, a person name display area 322, a title display area 323, a department display area 324, and the like are set. The user can set the field valuing method in the field binding area 350. The field valuing method may include automatic filling or manual filling. As to the automatic filling, the system obtains a source of the field, and retrieves desired information according to the source of the field. For example, when the source of the field is a name, relevant information about the name will be extracted from the event information and then displayed in the name display area. For another example, when the source of the field is a job title, relevant information about the job will be extracted from the event information and then displayed in the title display area. In some exemplary embodiments, the event information may be stored in the storage library by the user. The event information can be obtained by the server in the storage library according to the fields.

In some exemplary embodiments, after the name information is extracted, the user can select the name to be displayed in the name display column. After the user selects the name, the server can identify other information that matches the name based on the name information, such as company, job title, and the like, and display the same in the corresponding display column.

The user can adjust the display parameters for the related information of each field source in the template content input area 340, such as the displayed character size, character format, and the limited number of words in each display area. The character size can be set as a fixed size or set in an automatic adaptation manner. The character format includes the format and color of the displayed characters, for example, red Kaiti, black SongTi, red SongTi, and the like, which are not specifically limited in the exemplary embodiments.

After completing the above operations, the user can trigger the save control 370 to save the template and store it in the template library. If the template is not needed, the user can trigger the cancel control 360 to cancel the creation of the template.

In step S230, based on the event information, a picture corresponding to the event to be displayed is generated by using the target template.

In some exemplary embodiments of the disclosure, the server may extract service fields of the event to be displayed, such as name, title, price, and the like, and then input the service fields into the target template, so that the target template can obtain event information of the event to be displayed based on the service fields, and then use the target template to generate a picture corresponding to the event to be displayed. The event information can be obtained by the server in the storage library according to the service fields, or it can be directly input by the user. For example, the user inputs the event information of the event to be displayed through the template editing interface mentioned above, which is not specifically limited in the exemplary embodiments.

In some exemplary embodiments, the event to be displayed may include one or more targets to be displayed, and the picture corresponding to each target to be displayed can be generated by using the target template. For example, in the conference scenario, when the names of conference personnel need to be displayed, there may be multiple persons, and the selected target template for the conference scenario can be used to generate pictures for each target to be displayed, that is, generate multiple pictures, and each picture includes the name of one of the conference personnel.

For another example, when a variety of goods on the shelf needs to be priced, the selected target template for pricing can be used to generate pictures of the price obtained for each of the various goods on the shelf, that is, the target template can be used multiple times to generate pictures for the price of each kind of goods.

In step S240, the picture is displayed on an electronic signage corresponding to the event to be displayed.

In some exemplary embodiments of the disclosure, the pictures generated by using the target template can be displayed on the electronic signage corresponding to the event to be displayed. As described above, the electronic signage can be a display device that can display content, and can be a device that can be wall-mounted, placed, or portable, such as conference table cards, station cards, house cards, electronic work cards (also called electronic business cards), visitor cards, door plates for advertising display, elevator cards, bus stop signs, presentation signage used in museums or exhibition halls for display in different positions, and the like.

In some exemplary embodiments, referring to FIG. 4, before the image is displayed on the electronic signage corresponding to the event to be displayed, the method for displaying event information may further include steps S410 to S420, which will be described in detail hereafter.

In step S410, a map of multiple electronic signages is obtained.

In step S420, in response to a user operation, a target to be displayed is assigned to each of the electronic signages in the map.

In step S430, a picture to be displayed is bound to the electronic signage corresponding to one or more targets to be displayed.

In some exemplary embodiments, the server may first obtain the map of multiple electronic signages, that is, the location distribution of the multiple electronic signages, and then, in response to the user operation, assign a target to be displayed to each of the electronic signages in the map. In other words, a corresponding relationship between multiple targets to be displayed and multiple electronic signages, as well as a corresponding positional relationship are determined, where the positional relationship may refer to a transmission location on the network or a physical location of the electronic signage, which is not limited in the embodiments of the disclosure.

After the corresponding relationship between the electronic signage and the picture is determined, the picture can be modified into a readable format of the electronic signage according to the display format of the electronic signage, and then displayed on the electronic signage.

Specifically, for example, only three colors can be displayed on an electronic signage, but the picture generated by the target template includes four colors. At this time, the color of the picture can be adjusted so that the electronic signage can display the above picture. For another example, the electronic signage can display the picture of “.gif” format, but the format of the picture generated by the target template is “.jpg” format. At this time, the above picture can be converted into a picture in “.gif” format, thereby being displayed on the electronic signage.

In some exemplary embodiments, the server can directly display the above pictures on the corresponding electronic signage in response to the user's triggering operation. If the user needs to delay the display, the server can set a timed task so that the picture will be displayed on the corresponding electronic signage after a preset time, where the preset time may be 10 minutes, 20 minutes, one hour, and the like, or the preset time can be customized according to user needs, which is not limited in the exemplary embodiments. After the preset time lapses, the server triggers the delayed task and display the picture on the corresponding electronic signage.

In some exemplary embodiments, a specific preset time point can also be set, and the above-mentioned timed task is triggered when the preset time point is reached, then the picture is displayed on the corresponding electronic signage. For example, the preset time point is set at 2:15 pm, then the picture will be displayed on the corresponding signage at 2:15 pm. The specific time point can be customized by the user, and is not specifically limited in the exemplary embodiments.

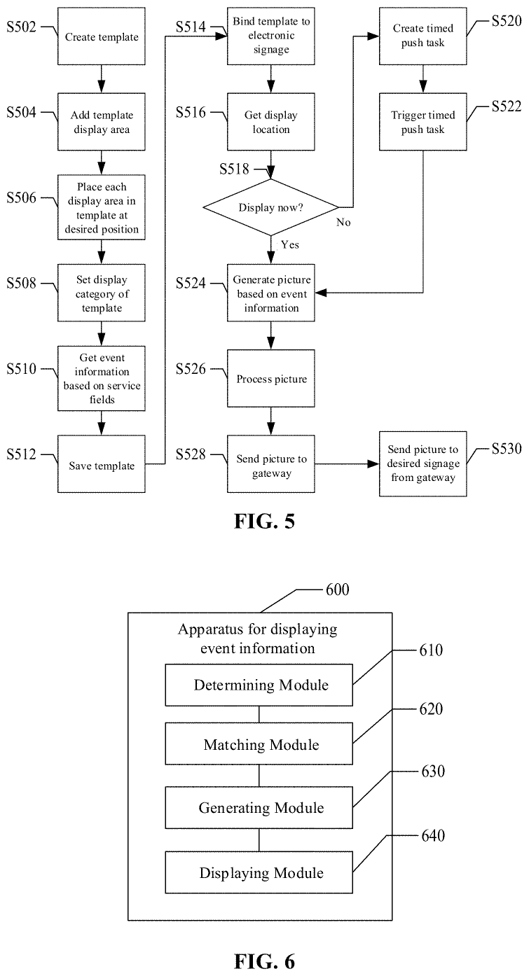

Hereinafter, the overall flow of the above method for displaying event information will be described with reference to FIG. 5.

In some exemplary embodiments, the user can first perform step S502, creating a template, step S504, adding a template display area, and step S506, placing each area of the template in a designated area. Specifically, a blank template is firstly created, and then at least one display area is added in the template as desired and the position of each display area is determined. Subsequently, step S508 can be executed to set the template display category and determine the display mode of the template, for example, text, image, two-dimensional code, and the like. Then, step S510 and step S512 can be executed, in which the template is saved and the event information is obtained according to the service field. The detailed description of how to obtain the event information according to the service field has been described in detail above, so it will not be repeated here.

After obtaining the above event information and saving the template, step S514, step S516, and step S518 can be performed to determine the location of each electronic signage, bind the location information of each signage to the event to be displayed, connect the template with the electronic signage, and determine whether the displaying is needed immediately. If the user needs to display the information immediately, step S524, step S526, step S528 and step S530 are executed, including generating a picture corresponding to the event to be displayed based on the event information, convert the picture into a readable format of the electronic signage before being sent to the gateway, which then sends the picture to the electronic signage. If it is determined that the user does not need to display the information immediately, step S520 and step S522 can be performed. Firstly, a timed push task is created and, then, triggered after a preset time point reached or after a preset time period lapses. Then, step S524, step S526, step S528, and step S530 are performed, thereby completing displaying the event information of the event to be displayed.

The following describes the apparatus embodiments of the disclosure, which can be used to implement the method for displaying event information described above in the disclosure. In some exemplary embodiments of the disclosure, an apparatus for displaying event information is provided. Referring to FIG. 6, the apparatus 600 for displaying event information includes: a determining module 610, a matching module 620, a generating module 630, and a displaying module 640.

The determining module 610 is configured to determine an event category and event information of an event to be displayed; the matching module 620 is configured to determine a target template in a template library according to the event category, wherein the template library comprises reference templates corresponding to multiple event categories; the generating module 630 is configured to generate, based on the event information, a picture corresponding to the event to be displayed by using the target template; the display module 640 is configured to display the picture on an electronic signage corresponding to the event to be displayed.

Since each functional module of the apparatus for displaying event information according to the exemplary embodiments of the disclosure corresponds to the steps as described in the above-mentioned method for displaying event information according to the exemplary embodiments, details thereof that are not disclosed in the apparatus embodiments of the disclosure may refer to the above-mentioned method for displaying event information according to the exemplary embodiments.

It should be noted that although several modules or units of the apparatus for action execution are mentioned in the above detailed description, this division is not mandatory. In fact, according to the embodiments of the disclosure, the features and functions of two or more modules or units described above may be embodied in one module or unit. Similarly, the features and functions of a module or unit described above can be further divided into multiple modules or units to be embodied.

In addition, in some exemplary embodiments of the disclosure, an electronic device for displaying event information is further provided.

Those skilled in the art can understand that various aspects of the disclosure can be implemented as a system, a method, or a program product. Therefore, various aspects of the disclosure can be specifically implemented in the following forms, including: a complete hardware embodiment, a complete software embodiment (including firmware, microcode, and the like), or a combination of hardware and software embodiments which may be collectively referred to herein as “circuit”, “module” or “system”.

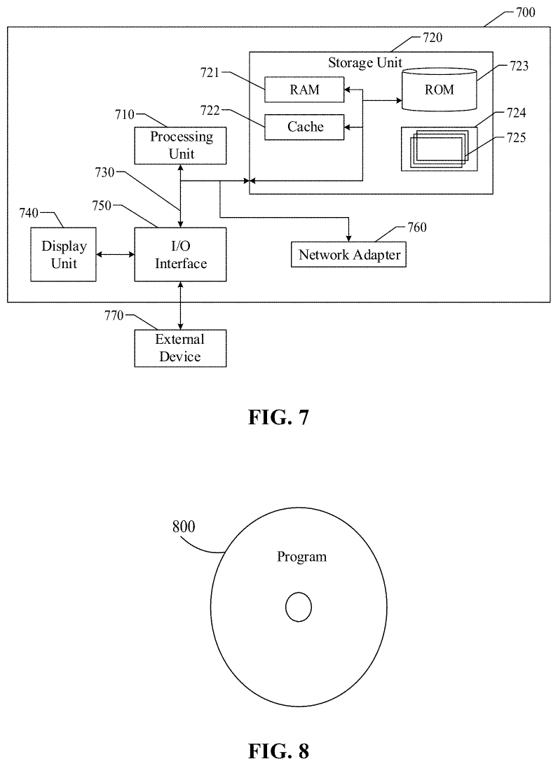

The electronic device 700 according to some embodiments of the disclosure will be described below with reference to FIG. 7. The electronic device 700 shown in FIG. 7 is only an example, and should not bring any limitation to the function and application scope of the embodiments of the disclosure.

As shown in FIG. 7, the electronic device 700 is represented in the form of a general-purpose computing device. The components of the electronic device 700 may include, but are not limited to, at least one processing unit 710, at least one storage unit 720, a bus 730 connecting different system components (including the storage unit 720 and the processing unit 710), and a display unit 740.

In some embodiments, the storage unit is configured to store program codes, which can be executed by the processing unit 710, thereby causing the processing unit 710 to execute steps of the various exemplary methods described in the exemplary method embodiments of the disclosure. For example, the processing unit 710 is configured to perform steps as shown in FIG. 2: S210, determining an event category and event information of an event to be displayed; S220, determining a target template in a template library according to the event category, wherein the template library includes reference templates corresponding to multiple event categories; S230, generating, based on the event information, a picture corresponding to the event to be displayed by using the target template; and S240, displaying the picture on an electronic signage corresponding to the event to be displayed.

For another example, the electronic device is configured to implement the steps shown in FIG. 2 or FIG. 4.

The storage unit 720 may include a readable medium in the form of a volatile storage unit, such as a random access storage unit (RAM) 721 and/or a cache storage unit 722, and may further include a read-only storage unit (ROM) 723.

The storage unit 720 may also include a program/utility tool 724 having a set of (at least one) program module 725. Such program module 725 includes, but is not limited to, an operating system, one or more application programs, other program modules, and program data. Each or some combination of these examples may include the implementation in a network environment.

The bus 730 may be represented as one or more of several types of bus structures, including a storage unit bus or a storage unit controller, a peripheral bus, a graphics acceleration port, a processing unit, or a local area bus using any bus structure among multiple bus structures.

The electronic device 700 may also communicate with one or more external devices 770 (e.g., keyboards, pointing devices, Bluetooth devices, and the like), and may also communicate with one or more devices that enable a user to interact with the electronic device 700, and/or communicate with any device (e.g., router, modem, and the like) that enables the electronic device 700 to communicate with one or more other computing devices. This communication can be performed through an input/output (I/O) interface 750. In addition, the electronic device 700 may also communicate with one or more networks (e.g., a local area network (LAN), a wide area network (WAN), and/or a public network such as the Internet) through the network adapter 760. As shown in the drawing, the network adapter 760 communicates with other modules of the electronic device 700 through the bus 730. It should be understood that although not shown in the drawing, other hardware and/or software modules can be used in conjunction with the electronic device 700, including but not limited to, microcode, device drivers, redundant processing units, external disk drive arrays, RAID systems, tape drives, data backup storage system, and the like.

Through the description of the above embodiments, those skilled in the art can easily understand that the exemplary embodiments described here can be implemented by software, or can be implemented by combining software with necessary hardware. Therefore, the technical solution according to the embodiments of the disclosure can be embodied in the form of a software product, and the software product can be stored in a non-volatile storage medium (which can be a CD-ROM, U disk, mobile hard disk, and the like) or on the network, and includes several instructions causing a computing device (which can be a personal computer, a server, a terminal device, or a network device, and the like) to execute the method according to the embodiments of the disclosure.

In some exemplary embodiments of the disclosure, there is also provided a computer-readable storage medium storing therein a program product capable of implementing the above-mentioned method in the disclosure. In some possible embodiments, various aspects of the disclosure may also be implemented in the form of a program product, which includes program codes. When the program product runs on a terminal device, the program codes cause the terminal device to execute the steps according to various exemplary embodiments of the disclosure described in the above-mentioned exemplary method embodiments of the disclosure.

Referring to FIG. 8, a program product 800 for implementing the above method according to the embodiments of the disclosure is illustrated, which can adopt the form of a portable compact disk read-only memory (CD-ROM) and include program codes, and can run in a terminal device, such as a personal computer. However, the program product of the disclosure is not limited thereto. In this disclosure, the readable storage medium can be any tangible medium that contains or stores a program, and the program can be used by or in combination with an instruction execution system, apparatus or device.

The program product can use any combination of one or more readable mediums. The readable medium may be a readable signal medium or a readable storage medium. The readable storage medium may be, for example, but not limited to, an electrical, magnetic, optical, electromagnetic, infrared, or semiconductor system, apparatus, or device, or a combination of any of the above. More specific examples (non-exhaustive list) of readable storage medium include: electrical connections using one or more wires, portable disks, hard disks, random access memory (RAM), read-only memory (ROM), erasable programmable read only memory (EPROM or flash memory), optical fiber, portable compact disk read only memory (CD-ROM), optical storage device, magnetic storage device, or any suitable combination thereof.

The computer-readable signal medium may include a data signal propagated in baseband or as a part of a carrier wave, with readable program codes being carried therein. This propagated data signal can take many forms, including but not limited to electromagnetic signals, optical signals, or any suitable combination thereof. The readable signal medium may also be any readable medium other than a readable storage medium, and the readable medium may send, propagate, or transmit a program for being used by or in combination with the instruction execution system, apparatus, or device.

The program code contained on the readable medium can be transmitted by any suitable medium, including but not limited to wireless, wired, optical cable, RF, or any suitable combination thereof.

The program codes used to perform the operations of the disclosure can be written in any combination of one or more programming languages. The programming languages include object-oriented programming languages, such as Java, C++, and the like, as well as conventional procedural programming language, such as “C” language or similar programming languages. The program codes can be entirely executed on the user's computing device, partly executed on the user's device, executed as an independent software package, partly executed on the user's computing device and partly executed on the remote computing device, or entirely on the remote computing device or server. In a case of the remote computing device, the remote computing device can be connected to a user computing device through any kind of network, including a local area network (LAN) or a wide area network (WAN), or it can be connected to an external computing device (e.g., connected via the Internet using Internet service providers).

In addition, the above-mentioned drawings are merely schematic illustrations of the processing included in the method according to the exemplary embodiments of the disclosure, and are not intended for limitation. It should be understood that the processing shown in the above drawings does not indicate or limit the time sequence of these processing steps. In addition, it should be understood that, for example, these processes can be executed synchronously or asynchronously in multiple modules.

Those skilled in the art will easily think of other embodiments of the disclosure after understanding the specification and practicing the embodiments disclosed herein. The disclosure is intended to cover any variations, uses, or adaptive changes of the disclosure, as long as these variations, uses, or adaptive changes follow the general principles of the disclosure and include common knowledge or conventional technical means in the technical field that are not disclosed in the disclosure. The description and the embodiments are only regarded as exemplary, and the true scope and spirit of the disclosure are limited by the claims.

It should be understood that the present disclosure is not limited to the precise structure that has been described above and shown in the drawings, and various modifications and changes can be made without departing from its scope. The scope of the present disclosure is limited only by the appended claims.

1. A method for displaying event information, comprising:
determining an event category and event information of an event to be displayed;
determining a target template in a template library according to the event category, wherein the template library comprises reference templates corresponding to multiple event categories;
generating, based on the event information, a picture corresponding to the event to be displayed by using the target template; and
displaying the picture on an electronic signage corresponding to the event to be displayed.

2. The method according to claim 1, further comprising:
determining whether there is a reference template matching the event category of the event to be displayed in the template library; and
determining, in response to determining there is the reference template matching the event category of the event to be displayed in the template library, the target template in the template library according to the event category.

3. The method according to claim 2, further comprising:
generating, in response to determining there is no reference template matching the event category of the event to be displayed in the template library, the target template according to the event category and storing the target template in the template library.

4. The method according to claim 1, wherein the generating, based on the event information, the picture corresponding to the event to be displayed by using the target template comprises:
determining a display mode and at least one display area of the target template according to the event category; and
determining a display size and a display parameter of each display area in the target template;
wherein the display mode comprises at least one of text, coded pattern and non-coded pattern.

5. The method according to claim 1, further comprising:
updating the target template in response to an editing operation of a user on the target template.

6. The method according to claim 5, wherein the updating the target template in response to the editing operation of the user on the target template comprises:
in response to a modification operation of the user on a display mode of the target template, modifying the display mode of the target template; and/or
in response to an adjustment operation of the user on a display area of the target template, adjusting at least one of a display size, number, and a display parameter of the display area.

7. The method according to claim 1, wherein the generating, based on the event information, the picture corresponding to the event to be displayed by using the target template comprises:
extracting a service field of the event to be displayed;
inputting the service field into the target template, causing the target template to obtain event information of the event to be displayed according to the service field; and
generating, based on the event information, the picture corresponding to the event to be displayed by using the target template.

8. The method according to claim 7, wherein the event to be displayed comprises at least one target to be displayed, and generating, based on the event information, the picture corresponding to the event to be displayed by using the target template comprises:
generating, based on the event information, a picture corresponding to each target to be displayed by using the target template.

9. The method according to claim 8, wherein before displaying the picture on the electronic signage corresponding to the event to be displayed, the method further comprises:
acquiring a map of multiple electronic signages;
assigning, in response to a user operation, a target to be displayed to each of the electronic signages in the map; and
binding a picture to be displayed to the electronic signage corresponding to one or more targets to be displayed.

10. The method according to claim 9, wherein the displaying the picture on the electronic signage corresponding to the event to be displayed comprises:
displaying, in response to a display triggering operation of a user, the picture on a corresponding electronic signage; or
displaying the picture on the corresponding electronic signage automatically after a preset time period, or
displaying the picture on the corresponding electronic signage automatically at a preset time point.

11. The method according to claim 10, wherein the displaying the picture on the electronic signage corresponding to the event to be displayed comprises:
converting the picture into a readable format of the electronic signage to be displayed on the electronic signage corresponding to the event to be displayed.

12. (canceled)

13. A non-transitory computer-readable storage medium storing a computer program therein, wherein the program is executable by a processor to implement a method for displaying event information, wherein the method comprising:
determining an event category and event information of an event to be displayed;
determining a target template in a template library according to the event category, wherein the template library comprises reference templates corresponding to multiple event categories;
generating, based on the event information, a picture corresponding to the event to be displayed by using the target template; and
displaying the picture on an electronic signage corresponding to the event to be displayed.

14. An electronic device, comprising:
a processor; and
a memory, configured to store one or more programs, wherein the one or more programs, when being executed by one or more processors, causes the one or more processors to perform:
determining an event category and event information of an event to be displayed;
determining a target template in a template library according to the event category, wherein the template library comprises reference templates corresponding to multiple event categories;
generating, based on the event information, a picture corresponding to the event to be displayed by using the target template; and
displaying the picture on an electronic signage corresponding to the event to be displayed.

15. The electronic device according to claim 14, wherein the one or more processors are further caused to perform:
determining whether there is a reference template matching the event category of the event to be displayed in the template library; and
determining, in response to determining there is the reference template matching the event category of the event to be displayed in the template library, the target template in the template library according to the event category.

16. The electronic device according to claim 15, wherein the one or more processors are further caused to perform:
generating, in response to determining there is no reference template matching the event category of the event to be displayed in the template library, the target template according to the event category and storing the target template in the template library.

17. The electronic device according to claim 14, wherein the one or more processors are further caused to perform:
determining a display mode and at least one display area of the target template according to the event category; and
determining a display size and a display parameter of each display area in the target template;
wherein the display mode comprises at least one of text, coded pattern and non-coded pattern.

18. The electronic device according to claim 14, wherein the one or more processors are further caused to perform:
updating the target template in response to an editing operation of a user on the target template.

19. The electronic device according to claim 18, wherein the one or more processors are further caused to perform:
in response to a modification operation of the user on a display mode of the target template, modifying the display mode of the target template; and/or
in response to an adjustment operation of the user on a display area of the target template, adjusting at least one of a display size, number, and a display parameter of the display area.

20. The electronic device according to claim 14, wherein the one or more processors are further caused to perform:
extracting a service field of the event to be displayed;
inputting the service field into the target template, causing the target template to obtain event information of the event to be displayed according to the service field; and
generating, based on the event information, the picture corresponding to the event to be displayed by using the target template.

21. The electronic device according to claim 20, wherein the event to be displayed comprises at least one target to be displayed, and the one or more processors are further caused to perform:
generating, based on the event information, a picture corresponding to each target to be displayed by using the target template.
